(19) United States
(12) Patent Application Publication
(10) Pub. No.: US 2026/0195563 A1
(43) Pub. Date: Jul. 9, 2026

(54) ELECTRONIC DEVICE AND METHOD FOR SECURING DATA EXCHANGE(S) VIA AN ARTIFICIAL INTELLIGENCE ALGORITHM WITHIN A COMMUNICATION INSTALLATION, RELATED AIRCRAFT AND COMPUTER PROGRAM

(71) Applicant: THALES, Meudon (FR)

(72) Inventors: Henri BELFY, TOULOUSE (FR); Simon LEGAVRE, TOULOUSE (FR)

(21) Appl. No.: 19/443,353

(22) Filed: Jan. 8, 2026

(30) Foreign Application Priority Data
Jan. 8, 2025 (FR) 25 00149

(51) Int. Cl. G06N 3/043; G06N 3/048; G06N 3/084; G06N 3/09; G06N 3/126; G06N 5/048; H04L 9/40

(52) U.S. Cl. CPC G06N 3/043; G06N 3/048; G06N 3/084; G06N 3/09; G06N 3/126; G06N 5/048; H04L 63/14

(57) ABSTRACT

This electronic device for securing data exchange(s) within an avionics communication installation comprises:
an acquisition module of at least one data message;
a processing module of the at least one message by implementing at least one function among a message filtering function, a malicious behavior detection function and a reaction function to a malicious behavior;
a restitution module to perform at least one action associated with a result obtained through the at least one function.

Each function includes a set of functional rules obtained through the implementation of an artificial intelligence algorithm including a fuzzy logic decision tree or a radial basis function network; each functional rule being configured to associate an output value with several discretized input values.

### CROSS-REFERENCE TO RELATED APPLICATIONS

This application is a U.S. non-provisional application claiming the benefit of French Application No. 25 00149, filed on Jan. 8, 2025, which is incorporated herein by reference in its entirety.

### FIELD

The present invention relates to an electronic device for securing data exchange(s) within an electronic communication installation, as well as an aircraft comprising an electronic communication installation and such an electronic security device.

The invention also relates to a method for securing data exchange(s) within an electronic communication installation, implemented by such an electronic security device, as well as a non-transitory computer-readable medium including a computer program, including software instructions that implement such a security method when executed by a computer.

The invention relates to the field of cybersecurity, particularly in the avionics domain.

It specifically applies to several types of security measures that include filtering mechanisms, network intrusion detection and prevention mechanisms, also known as NIDS (Network Intrusion Detection System) and NIPS (Network Intrusion Prevention System), and local intrusion detection and prevention mechanisms within a system, also known as HIDS (Host-based Intrusion Detection System) and HIPS (Host-based Intrusion Prevention System).

An IDS (Intrusion Detection System) is a system to detect an intrusion. This can be host-based (HIDS) or network-based (NIDS).

A NIDS concerns software designed to monitor and analyze activity at the interfaces of a system. It compares the activities observed with predefined patterns of normal behavior or known attack patterns and generates an alert characterizing the events encountered. If a reaction function is associated with this detection mechanism that enables containing an attack (typically a filtering function), it is then called a NIPS.

A HIDS concerns software designed to monitor and analyze the activity of a single computer or computer system. The HIDS monitors events on the host computer, compares the activities observed with predefined patterns of normal behavior or known attack patterns and generates an alert characterizing the events encountered. If a reaction function is associated with this detection mechanism that enables containing an attack, it is then called an HIPS.

### BACKGROUND

The article “A comprehensive review of AI based intrusion detection system” by T. Sowmya and E. A. Mary Anita, published in 2023, compares existing works on artificial intelligence-based classification engines for intrusion detection mechanisms. These typically rely on the following algorithms or models: k-Nearest Neighbor (k-NN), Support Vector Machine (SVM), Naive Bayes (NB), Random Forest (RF), Decision Tree (DT), and Stochastic Gradient Descent (SGD).

These different algorithms or models are generally quite accurate and/or efficient, but are not well suited for implementation in security devices that that must be certified.

For security devices that that must be certified, it is known to use sets, or bases, of rules written in the form of detection equations, and these equations are manually created by a cybersecurity designer.

### SUMMARY

The purpose of the invention is to propose an electronic device and a method for securing data exchange(s), within an electronic communication installation, that are more suitable for certification.

To this end, the invention relates to an electronic security device for securing data exchange(s) within an avionics communication installation embedded on board an aircraft, the security device being configured to be embedded on board the aircraft and comprising:
an acquisition module configured to acquire at least one data message within the communication installation;
a processing module configured to process the at least one acquired message by implementing at least one function chosen from the group comprising: a message filtering function, a malicious behavior detection function, and a reaction function to a malicious behavior;
a restitution module configured to perform at least one action associated with a result obtained through the implementation of the at least one function and chosen from the group comprising: displaying the result on a display device, recording the result for later analysis, issuing an alert related to the result, and generating a command instruction for a system based on the result;
each function including a set of functional rules obtained through the implementation of an artificial intelligence algorithm chosen from an artificial intelligence algorithm including a fuzzy logic decision tree and an artificial intelligence algorithm including a radial basis function network, known as RBFN; each functional rule being, respectively, a filtering rule for the filtering function, a detection rule for the detection function, and a reaction rule for the reaction function; each functional rule being an association rule configured to associate an output value with several discretized input values.

With the security device according to the invention, the artificial intelligence algorithm implemented to obtain the set of functional rules is not based on a statistical approach, but on a pre-learned rule of association basis, and enables verification of the different parameters by an auditor and thus making the set of functional rules able to be audited and certified.

This artificial intelligence algorithm also enables making the set of functional rules able to be explained and predictable.

In contrast, the aforementioned state of the art deep learning techniques, such as SVM or RF, are based on black-box artificial intelligence techniques that enable performing the desired detection but are not able to be explained or deterministic.

Furthermore, the aforementioned article by T. Sowmya and E. A. Mary Anita, in section “3.1.2.2 Fuzzy C means clustering algorithm”, describes an unsupervised approach that enables assigning data points to one or more clusters. The algorithm assigns degrees of membership based on the distance between cluster centers and data points. The model aims to provide better accuracy and stability of classification when tested and trained with the KDD 99 Cup dataset. The algorithm is a fuzzy clustering approach, assigning each data sample to a cluster based on a probability score. The principle of fuzzy clustering for intrusion detection is to identify and categorize different types of attacks. This article also does not aim to provide an explainable and predictable set of functional rules, where each functional rule is configured to associate an output value with several discretized input values.

The electronic security device according to the invention is thus much more suitable for certification than the state-of-the-art NIDS, NIPS, HIDS and HIPS systems.

According to other advantageous aspects of the invention, the electronic security device comprises one or more of the following features, taken individually or in any technically possible combination:
the fuzzy logic decision tree includes at least one fuzzy inference system, each fuzzy inference system being configured to receive at least one value of a quantity related to the message, as input, and to deliver an evaluation value, as output; for each fuzzy inference system, a correspondence between input(s) and output is established by a fuzzy transformation of the inputs, to select the functional rule configured to associate an output value corresponding to several discretized input values;
the RBFN includes an input layer of N input node(s), each input node receiving a value of a quantity related to the message, a single intermediate layer of H neuron(s), and an output layer of S output node(s), each output node providing an evaluation value; N, H, and S being integers greater than or equal to 1, each neuron of the intermediate layer being characterized by a radial activation function centered on a center cₕ and radius rₕ, h being an integer between 1 and N;
the artificial intelligence algorithm is trained via preliminary learning from training data;
the preliminary learning preferably being supervised learning;
the preliminary learning of the fuzzy logic decision tree is performed through the implementation of a genetic algorithm;
the preliminary learning of the RBFN is performed through the implementation of gradient descent; and
the preliminary learning further includes, for each functional rule, an indication of the number of occurrences of the implementation of said rule during the preliminary learning.

The invention also relates to an aircraft comprising an electronic communication installation and an electronic security device for securing data exchange(s) within said communication installation, the electronic security device being as defined above.

The subject of the invention is also a security method for securing data exchange(s) within an avionics communication installation embedded on board an aircraft, the security method being implemented by an electronic security device embedded on board the aircraft and comprising:
acquiring at least one data message within the communication installation;
processing the at least one acquired message by implementing at least one function chosen from the group comprising: a message filtering function, a malicious behavior detection function, and a reaction function to a malicious behavior;
performing at least one action associated with a result obtained through the implementation of the at least one function and chosen from the group comprising: displaying the result on a display device, recording the result for later analysis, issuing an alert related to the result, and generating a command instruction for a system based on the result;
each function including a set of functional rules obtained through the implementation of an artificial intelligence algorithm chosen from an artificial intelligence algorithm including a fuzzy logic decision tree and an artificial intelligence algorithm including a radial basis function network, known as RBFN; each functional rule being, respectively, a filtering rule for the filtering function, a detection rule for the detection function, and a reaction rule for the reaction function; each functional rule being an association rule configured to associate an output value with several discretized input values.

The invention also relates to a non-transitory computer-readable medium including a computer program including software instructions that implement a security method as defined above when executed by a computer.

### BRIEF DESCRIPTION OF THE DRAWINGS

These features and advantages of the invention will become clearer upon reading the following description, given solely by way of non-limiting example, and made with reference to the appended drawings, wherein:

FIG. 1 is a schematic representation of an aircraft according to the invention comprising a communication installation compartmentalized into an avionics domain and an open domain external to the avionics domain; the communication installation including several avionics systems belonging to the avionics domain, one or more electronic devices belonging to the open domain, an electronic device for securing data exchange(s) within the installation, and an electronic communication gateway connected between the electronic devices and the avionics systems, the security device being configured to implement a set of functional rules obtained through the implementation of an artificial intelligence algorithm; and

FIG. 2 is a schematic representation of a communication supervision system resulting from another example of implementation of the invention;

FIG. 3 is a schematic view representing membership functions for two respective message parameters, according to a first embodiment of the invention wherein the artificial intelligence algorithm includes a fuzzy logic decision tree;

FIG. 4 is a schematic view representing a membership function for an evaluation value, according to the first embodiment; and

FIG. 5 is a flowchart of a method, according to the invention, for securing data exchange(s) within the avionics communication installation of FIG. 1, the method being implemented by the security device.

### DETAILED DESCRIPTION

The expressions “substantially equal to” and “of the order of” define a relationship of equality plus or minus 20%, preferably plus or minus 10%, and more preferably plus or minus 5%.

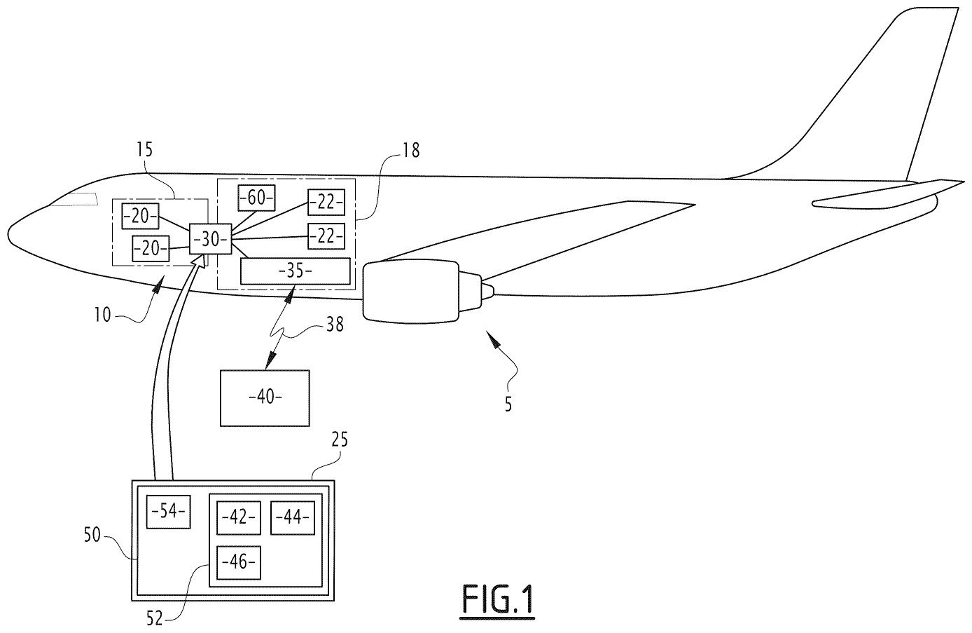

In FIG. 1, an aircraft 5 comprises a communication installation 10 compartmentalized into an avionics domain 15 and an open domain 18, external to the avionics domain 15.

The communication installation 10 includes several avionics systems 20 belonging to the avionics domain 15, as well as one or more electronic devices 22, external to the avionics domain 15 and belonging to the open domain 18.

The communication installation 10 also includes an electronic device 25 for securing data exchange(s).

In the example of FIG. 1, the communication installation 10 includes an electronic communication gateway 30 connected between the electronic devices 22 and the avionics systems 20. In the example of FIG. 1, the communication installation 10 includes several electronic devices 22, each belonging to the open domain 18. In this example of FIG. 1, the security device 25 is included in the electronic communication gateway 30.

Additionally, the communication installation 10 further comprises a communication server 35 communicating via a communication link 38 with at least one piece of electronic equipment 40, external to the aircraft 5.

The avionics domain 15 is a domain corresponding to the highest security level on board the aircraft 5, in particular the highest required security level of the communication installation 10 of the aircraft 5.

The avionics domain 15 is then a domain to limit a risk of disruption—by at least one communication with an electronic device or device external to the avionics domain 15—of function(s) implemented by the at least one avionics system 20 of the avionics domain 15. The avionics domain 15 includes the avionics system(s) 20.

The avionics domain 15 is typically the ACD domain (Aircraft Control Domain) according to the ARINC 811 standard of Dec. 20, 2005.

The open domain 18 is a domain to which a lower security level corresponds than the security level of the avionics domain 15. The open domain 18 includes the electronic device(s) 22.

Each avionics system 20 is embedded on board the aircraft 5 and belongs to the avionics domain 15. Each avionics system 20, also called an avionics computer, is known per se and is configured to implement one or more respective avionics functions.

Each avionics system 20 is chosen, for example, from the group consisting of: a flight management system, also called FMS (Flight Management System); a guidance system, or FG (Flight Guidance); a flight control system, or FCS (Flight Control System); a satellite positioning system GNSS (Global Navigation Satellite System), such as a GPS system (Global Positioning System); an inertial reference system, also called IRS (Inertial Reference System); an instrument landing system ILS (Instrument Landing System) or a microwave landing system MLS (Microwave Landing System); an active runway overrun prevention system, also called ROPS (Runway Overrun Prevention System); and a radio altimeter, also noted RA (Radio Altimeter).

Each electronic device 22 belonging to the open domain 18 does not implement a respective avionics function and therefore generally does not require specific certification.

The electronic security device 25 is configured to secure data exchanges within the avionics communication installation 10 and comprises an acquisition module 42, a processing module 44 and a restitution module 46.

The electronic security device 25 comprises an information processing unit 50, for example, typically formed of a memory 52 and a processor 54 associated with the memory 52.

According to this example, the acquisition module 42, the processing module 44 and the restitution module 46 are each implemented in the form of software, or a software brick, executable by the processor 54. The memory 52 of the security device 25 is then able to store acquisition software, processing software and restitution software. The processor 54 of the security device 25 is then able to execute each software program of the acquisition software, the processing software and the restitution software.

In an unrepresented variant, the acquisition module 42, the processing module 44 and the restitution module 46 are each implemented in the form of a programmable logic component, such as an FPGA (Field Programmable Gate Array), or an integrated circuit, such as an ASIC (Application Specific Integrated Circuit).

When the electronic security device 25 is implemented in the form of one or more software programs, i.e. in the form of a computer program, also called a computer program product, it is also able to be recorded on a medium, not represented, readable by a computer. The computer-readable medium is a medium capable of storing electronic instructions and being coupled to a computer system bus, for example. For example, the readable medium is an optical disk, a magneto-optical disk, a ROM memory, a RAM memory, any type of non-volatile memory (for example EPROM, EEPROM, FLASH, NVRAM), a magnetic card, or an optical card. A computer program comprising software instructions is then stored on the readable medium.

The electronic communication gateway 30, hereinafter referred to as the communication gateway 30 or simply gateway 30, interfaces between the open domain 18 and the avionics domain 15. A data message transmitted between the open domain 18 and the avionics domain 15, i.e. from the open domain 18 to the avionics domain 15 or vice versa from the avionics domain 15 to the open domain 18, necessarily transits through the communication gateway 30.

The communication server 35 is configured to communicate via the communication link 38 with at least one piece of external electronic equipment 40, said at least one piece of external electronic equipment 40 being a ground station or cloud computing equipment, for example. The communication server 35 is preferably connected to the communication gateway 30. The communication server 35 typically belongs to the open domain 18.

The communication server 35 is known per se and specifically includes a transceiver, not represented, compatible with the communication link 38. The communication link 38 is typically a radio link, i.e. a link by radio waves such as a satellite link. The transceiver is then a radio transceiver.

The external electronic equipment 40 is typically connected to an IT infrastructure of an operational control center, also called OCC (Operational Control Center). The external electronic equipment 40 is then advantageously configured to transmit data, such as a flight plan of the aircraft 5 and information related to the aircraft 5, such as its mass, configuration, balance, or its identifier.

The acquisition module 42 is configured to acquire at least one data message within the communication installation 10.

The acquisition module 42 is configured to acquire, for example, from an electronic device 22 belonging to the open domain 18, at least one data message intended for a respective avionics system 20, belonging to the avionics domain 15. The electronic device 22 from which the message is acquired is typically the communication server 35, if the message is sent from the external electronic equipment 40.

The acquisition module 42 is configured to acquire each message according to a respective avionics communication protocol, for example.

The avionics communication protocol is chosen, for example, from the group consisting of: a protocol compliant with the ARINC 702 standard; a protocol compliant with the ARINC 739 standard; a protocol compliant with the ARINC 619 standard; a protocol compliant with the ARINC 429 standard; and a protocol compliant with the FANS (Future Air Navigation System) A standard associated with EUROCAE ED-100.

The messages are messages coming from outside the security device 25, such as messages exchanged between the avionics domain 15 and the open domain 18.

Additionally, or in a variant, the messages are messages derived from any internal information source to a software application and/or hardware monitored by the security device 25. The messages are messages from one or more software probes of the software application itself, for example. Additionally, or in a variant, the messages are error messages from an operating system, or OS, of a computer system hosting the security device 25, said computer system then forming the information processing unit 50.

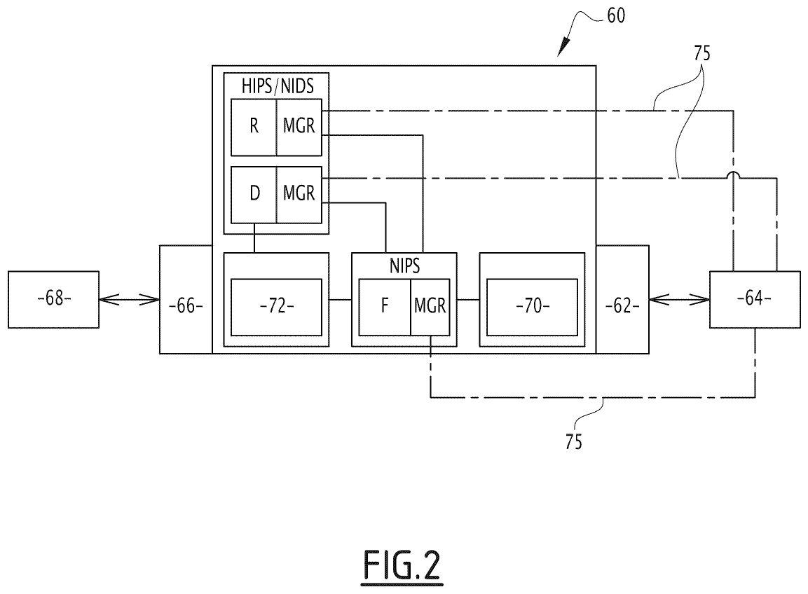

The processing module 44 is configured to process the at least one acquired message by implementing a filtering function F of the message and/or a detection function D of a malicious behavior and/or a reaction function R to a malicious behavior, the filtering functions F, detection D and reaction R being illustrated in FIG. 2, described in more detail below.

According to the invention, each filtering function F, detection D and/or reaction R includes a set of functional rules obtained through the implementation of an artificial intelligence algorithm. Each functional rule is, respectively, a filtering rule for the filtering function F, a detection rule for the detection function D, and a reaction rule for the reaction function R. Each functional rule is an association rule configured to associate an output value of a variable, also called output value, with several discretized input values of variables, also called input values.

The artificial intelligence algorithm has been trained previously via preliminary learning, from training data. The preliminary learning is advantageously supervised learning.

Optionally, the preliminary learning includes, for each functional rule, an indication of the number of occurrences of the implementation of said rule during the preliminary learning.

The skilled person will then understand that each set of functional rules is obtained through an inference of the artificial intelligence algorithm, the inference typically being performed dynamically during the implementation of the security device 25, and that, before this inference, the artificial intelligence algorithm has been trained during the preliminary learning from the training data. The training of the artificial intelligence algorithm is preferably performed only statically.

The restitution module 46 is configured to perform at least one action associated with a result obtained through the implementation of at least one filtering function F, detection D and/or reaction R, the action being chosen from displaying the result on a display device, not represented, recording the result for later analysis, the result being recorded in memory 52, for example, issuing an alert related to the result, and generating a command instruction for a system, such as a respective avionics system 20, based on the result.

The input variables taken into account to obtain the set of functional rules are variables corresponding to information from the hardware, for example, and/or variables corresponding to information from the operating system and/or application software, and/or variables corresponding to information from a communication network within the avionics installation 10.

The information derived from the hardware and likely to form input variables are typically the following:
memory errors: parity errors or ECC (Error-Correcting Code) errors on the RAM can indicate hardware problems or attempts to corrupt memory;
disk failures: frequent read/write errors, increasing bad sectors, or SMART (Self-Monitoring, Analysis and Reporting Technology) messages indicating imminent hard drive failure;
temperature issues: abnormally high temperatures of components like the CPU, GPU or hard drives can signal an overload, a cooling system failure, or an attack causing hardware overconsumption;
voltage variations: fluctuations or anomalies in power supply voltages can indicate an electrical problem or malicious hardware manipulation;
controller errors: anomalies in controllers such as disk controllers or network controllers can signal hardware failures or attacks aimed at disabling these components;
device failures: devices like network cards, graphics cards, or even USB devices that disconnect or operate intermittently can be signs of hardware issues or a compromise;
hardware diagnostic alerts: integrated hardware diagnostic tools reporting frequent or unusual errors can also indicate hardware anomalies;
abnormal BIOS/EFI events: unauthorized or repeated changes to BIOS/EFI settings, or failures in integrity or authenticity verification (secure boot) at startup can indicate firmware-level attack attempts;
performance anomalies: abnormally slow operation or excessive resource usage without a clear reason can also signal a hardware problem or malware consuming resources;
network performance issues: anomalies in network hardware components (like switches, hubs, internal routers) can indicate attempts to intercept or manipulate network traffic;
physical intrusions: detection of openings or forced modifications on the chassis or shielded components can indicate physical intrusion attempts;
processor hardware logs: monitoring CPU error messages, including privilege violations or illegal instructions, can indicate suspicious activities;
attacks on TPM (Trusted Platform Module) modules: abnormal activity or errors from the TPM module, possibly indicating attempts to bypass hardware security measures;
abnormal interruptions of an internal bus: unexpected disruptions or interruptions on internal communication buses, such as PCIe or SATA, can signal electronic intrusion attempts.

The information derived from the operating system and/or application software and likely to form input variables are typically the following:
unauthorized modifications of system files: any unexpected modification of critical system files (like system files, kernel executables, configuration files, etc.) can indicate a compromise;
repeated authentication failures: a series of successive authentication failures can signal a brute force attempt to access the system;
abnormal system resource usage: excessive and unusual usage of system resources like CPU, RAM, or disk I/O can indicate malware or an undesirable process;
suspicious processes: execution of unexpected processes, or hidden processes that are not typically present on the system can signal an intrusion;
security rule modifications: unauthorized changes in firewall configurations, SELinux/AppArmor rules, or other security policies;
unexpected creation or deletion of users: unexpected creation or deletion of user accounts, or modification of user privileges can indicate an attempt to take control of the system;
abnormal network connections: unusual outgoing or incoming connections, especially from or to non-standard ports or unexpected geographical locations;
system service errors: repeated failures or services frequently restarting can indicate attempts to exploit service vulnerabilities;
system log modifications: modification or deletion of system logs to try to hide malicious actions;
unauthorized execution of scripts/programs/processes: software running in the background without authorization can indicate the presence of malware or remote-control scripts;
code injections: attempts to inject code into legitimate processes using techniques like DLL Injection or Code Cavitation;
scheduled task activities: monitoring scheduled tasks to detect suspicious additions or abnormal behaviors;
anomalies in access rights: unexpected changes in permissions of critical files and folders;
abnormal file system behaviors: changes in file systems like excessive write/read activity, file corruption, or files appearing out of nowhere;
abnormal boot sequences: changes in the boot sequence or modifications of boot configurations (like EFI or MBR boot partitioning); and
anomalies in user sessions: user sessions open during inactivity hours, rapid session changes, or unexpected simultaneous connections from different IP addresses.

The information derived from the communication network and likely to form input variables are typically the following:
frame frequency: monitoring an abnormally high or low frequency of frame transmission on the network; a higher than usual frequency can indicate malicious behavior, such as a denial of service (DDoS) attack or an attempt to exfiltrate data; an abnormally low frequency can signal network performance or hardware issues;
flow syntax: checking if packets comply with expected protocols and data formats; anomalies in packet syntax can indicate the presence of malicious packets or attempts to exploit protocol vulnerabilities;
time between two frames: detecting abnormal variations in the time between successive frames; abnormally short interval times could indicate an attempt to overload the network, while longer times could signal latency issues or packet suppression attacks;
frame size: tracking anomalies in the size of transmitted frames; abnormally large or small frames can be signs of malicious fragmentation attempts, tunneling techniques, or detection system bypassing;
frame semantics: analyzing the content of frames to detect anomalies in transmitted data; for example, requests or responses that do not match the expected context can indicate command injection attacks or data manipulation;
frame order: monitoring the order of transmitted frames; a sequence of frames that does not match the expected order (indicating retransmissions or rearranged packets) can signal a “man-in-the-middle” attack, where the attacker intercepts and modifies frames during transmission.

The sanctions or reactions likely to be implemented in case of detection of malicious behavior are typically the following:
blocking access: blocking incoming or outgoing connections from suspicious or malicious addresses, thus preventing the attacker from accessing the host;
process interruption: if a malicious or suspicious process is detected, terminating it immediately, to resume activity in a trusted state;
firewall rule modification: dynamically adjusting firewall rules to block specific ports or protocols associated with a threat;
host isolation: isolating a compromised host from the network to prevent the attack from spreading to other systems;
access privilege reduction: if an anomaly is detected, temporarily reducing the access privileges of a user or process, thus preventing potentially harmful actions; and
logging and alerting: recording all events and send alerts to administrators, enabling for a quick response.

The skilled person will understand that the input variables indicated above are usable for both the filtering function F, the detection function D and the reaction function R. The input variables are then each usable as respective inputs of a fuzzy inference system, optionally also as input the output of another fuzzy inference system when several fuzzy inference systems are cascaded within a corresponding fuzzy logic decision tree (as described in more detail below), and the output variable of each fuzzy inference system is likely to contribute to the filtering function F and/or the detection function D and/or the reaction function R.

For example, reaching a predefined threshold by the output variable of a respective fuzzy inference system can be used to reject a frame or to block access, with this corresponding to the filtering function F.

As a complementary example, reaching the predefined threshold by the output variable of a respective fuzzy inference system can be used to initiate logging (log), with this then corresponding to the detection function D.

As a further complementary example, reaching the predefined threshold by the output variable of a respective fuzzy inference system can be used to restart software and/or hardware partition, with this then corresponding to the reaction function R.

The skilled person will also observe that the reaction function R generates more background processing (stopping a process, restarting a partition), the filtering function F targets the element transmitting the attack (such as the attacking frame) more, and the detection function D is useful specifically for intelligent recording aspects.

It is also noted that the output variables of the detection function D can form input variables of the reaction function R; that the output variables of the filtering function F can form input variables of the detection function D and/or the reaction function R; and/or that the output variables of the detection function D and/or the reaction function R can form input variables of the filtering function F.

In FIG. 2, the invention is implemented within a communication or data exchange supervision system 60 including first interfaces 62, also called untrusted interfaces, connected to one or more first piece(s) of equipment 64; and second interfaces 66, also called trusted interfaces, connected to one or more second piece(s) of equipment 68.

The supervision system 60 includes a first manager 70 configured to manage the first interfaces 62, i.e. untrusted, and, specifically, to retrieve potentially malicious data, and a second manager 72 configured to manage the second interfaces 66, i.e. trusted, and, specifically, to transfer sanitized data to a trusted domain such as the avionics domain 15.

To this end, the supervision system 60 includes the filtering function F, interconnected between the first manager 70 and the second manager 72, to filter the potentially malicious data retrieved by the first manager 70 and provide the filtered, i.e. sanitized, data to the second manager 72 for transmission to the trusted domain. The filtering function F then corresponds to a NIPS-type functionality. In the example of FIG. 2, the filtering function F is associated with a rule generation engine RGE to generate the filtering rule(s) associated with the filtering function F, these being obtained according to the invention through the implementation of the artificial intelligence algorithm.

Additionally, the supervision system 60 includes the detection function D, configured specifically to detect intrusions or intrusion attempts, and/or the reaction function R, configured specifically to react to one or more intrusions or intrusion attempts detected by the detection function D.

The detection function D is based on the elements observed by the other functions of the supervision system 60 and is configured to implement the detection rule(s), to determine if one or more malicious events occur within the supervision system 60. In the example of FIG. 2, the detection function D is associated with the rule generation engine RGE, to generate the detection rule(s) associated with the detection function D, these being obtained according to the invention through the implementation of the artificial intelligence algorithm.

The reaction function R is configured to implement the reaction rule(s), to apply one or more sanctions related to a behavior observed by the detection function D. In the example of FIG. 2, the reaction function R is associated with the rule generation engine RGE, to generate the reaction rule(s) associated with the reaction function R, these being obtained according to the invention through the implementation of the artificial intelligence algorithm.

The detection D and reaction R functions then typically correspond to a HIPS-type functionality and/or a NIDS-type functionality.

In the example of FIG. 2, to perform the learning of the artificial intelligence algorithm implemented by the rule generation engine RGE, an intelligent router, or a simulation of this intelligent router, as well as one or more piece(s) of real equipment, or simulation thereof, are connected to the supervision system 60 as first equipment 64. The intelligent router, or simulation thereof, is then implemented according to different successive scenarios, namely nominal scenarios, as well as attack scenarios, aimed at covering all desired use cases, indicating, for each scenario, the expected behavior to the artificial intelligence algorithm. During this learning, the intelligent router communicates with each rule generation engine R via a respective link 75, also called a learning link.

The artificial intelligence algorithm is in ONNX format (Open Neural Network Exchange), for example, which enables having the rule generation engine RGE also in ONNX format. The ONNX format is an open standard designed to represent machine learning models. It enables interoperability between different tools, frameworks and deep learning platforms. In a variant, the artificial intelligence algorithm is in a proprietary format.

According to a first embodiment of the invention, the artificial intelligence algorithm implemented to obtain the set of functional rules includes a fuzzy logic decision tree, also called GFT (Genetic Fuzzy Tree). The fuzzy logic decision tree has the advantage of making the set of functional rules explainable and predictable.

The fuzzy logic decision tree includes at least one fuzzy inference system, and each fuzzy inference system is configured to receive at least one value of a quantity related to the message as input and to deliver an evaluation value as output. For each fuzzy inference system, a correspondence between input(s) and output is established by a fuzzy transformation of the inputs, to select the functional rule, also called GFT rule, configured to associate an output value corresponding to several discretized input values.

The preliminary learning of the fuzzy logic decision tree is performed through the implementation of a genetic algorithm.

Each fuzzy inference system is characterized by three successive phases:
a first phase, called conversion to fuzzy values, or fuzzy generation, or fuzzification, corresponding to the process of converting precise values into fuzzy values, by associating them with fuzzy sets using membership functions;
a second phase, called inference, or implementation of the inference engine, during which one or more rules are applied to characteristics, or adjectives, representing the inputs (fuzzy operators) to thus create new characteristics, or new adjectives, images of said rules; and
a third phase, called conversion to precise values, or fuzzy resolution, or defuzzification, during which a fuzzy decision, typically with a value between 0% and 100%, is deduced from the values of the new adjectives inferred by the rules.

An example of obtaining a fuzzy rule will now be described for a use case associated with a computer firewall.

The purpose of the fuzzy rule is to estimate a DDOS attack level as an evaluation value, i.e. as the output variable of the fuzzy rule, from two quantities or parameters related to the data message, forming the input variables of the fuzzy rule. For this example, the quantities related to the message are a frequency of sending a data frame and a size of the data frame sent.

Optionally, a normalization preprocessing is performed on the input data, to normalize them, between 0 and 1, for example. The normalization preprocessing of the size then typically consists of dividing a current size of the frame by a predefined maximum size, such as 8192 bytes, to obtain a normalized size of between 0 and 1. Similarly, the normalization preprocessing of the frequency typically consists of dividing a current frequency by a predefined maximum frequency, such as 1 kHz, to obtain a normalized frequency of between 0 and 1.

In the aforementioned example, for the first phase, the inputs are in the form {Frequency, Size}={0.2; 0.5}, for example.

The fuzzy inference system will measure the membership of each of these two variables to the input adjectives: Frequency: {LOW, MEDIUM, HIGH}; and Size: {LOW, MEDIUM, HIGH}.

The membership functions to these adjectives are triangular functions, for example, classified by their centers, and each extending from the previous center to the next center. In accordance with a stochastic process, this enables having the sum of all membership functions equal to 1 for a fixed value on a given abscissa.

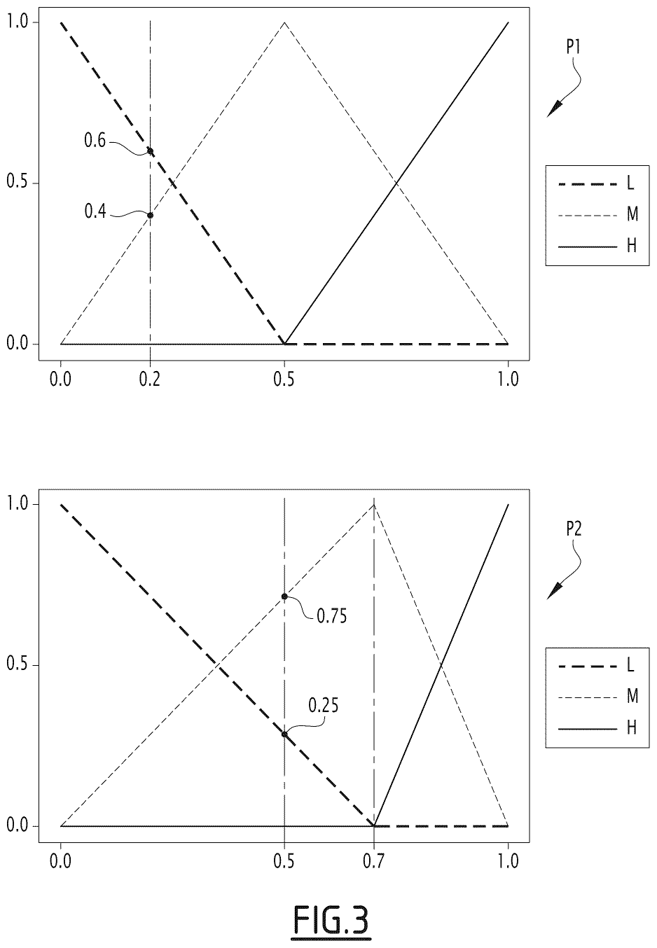

The membership functions of this example are then represented in FIG. 3, where the view P1, for the first parameter P1, corresponds to the Frequency, and the respective view P2, for the second parameter P2, corresponds to the Size. In this example, the centers of the membership functions for the Frequency are then {0; 0.5; 1}, and those of the membership functions for the Size are {0; 0.7; 1}. In FIG. 3, the adjective LOW corresponds to the letter L, the adjective MEDIUM corresponds to the letter M, and the adjective HIGH corresponds to the letter H.

The first phase of fuzzy generation then enables classifying the input variable(s), according to several adjectives.

In the example, the associated function F is as follows: F: real→triplet in [0; 1]³, with:
F: (Frequency: 0.2)→{LOW: 60%, MEDIUM: 40%, HIGH: 0%}
F: (Size: 0.5)→{LOW: 25%, MEDIUM: 75%, HIGH: 0%}

During the second inference phase, the rules enable inferring membership to adjectives, to classify the output variable, from the adjectives associated with the input variables. The inference engine then takes the output of the first fuzzy generation phase, i.e. the classification of the initial input variables, as input.

In the example, the input of the inference engine is then: Frequency {LOW: 60%, MEDIUM: 40%, HIGH: 0%} and Size {LOW: 25%, MEDIUM: 75%, HIGH: 0%}.

As there are three adjectives classifying each of the two input variables, this gives nine different combinations, or nine rules, in this example.

The inference engine is configured from said rules.

In the example, these nine unitary rules are assumed to be the following:
1. IF {Frequency}LOW & {Size}LOW, THEN {DDOS LEVEL}VERY_VERY_LOW
2. IF {Frequency}LOW & {Size}MEDIUM, THEN {DDOS LEVEL}VERY_LOW
3. IF {Frequency}HIGH & {Size}LOW, THEN {DDOS LEVEL}LOW
4. IF {Frequency}LOW & {Size}HIGH, THEN {DDOS LEVEL}VERY_VERY_MEDIUM
5. IF {Frequency}MEDIUM & {Size}LOW, THEN {DDOS LEVEL}VERY_MEDIUM
6. IF {Frequency}MEDIUM & {Size}MEDIUM, THEN {DDOS LEVEL}MEDIUM
7. IF {Frequency}MEDIUM & {Size}HIGH, THEN {DDOS LEVEL}HIGH
8. IF {Frequency}HIGH & {Size}MEDIUM, THEN {DDOS LEVEL}VERY_HIGH
9. IF {Frequency}HIGH & {Size}HIGH, THEN {DDOS LEVEL}VERY_VERY_HIGH

In this example, for simplification reasons, only the logical AND operator, symbolized by the sign &, is used, and is interpreted as the product operator.

The nine previous rules are then mathematically translated as follows:

$$1. DDOS\_LEVEL \_VERY \_VERY \_LOW = Frequency\_LOW * Size\_LOW$$

$$2. DDOS\_LEVEL \_VERY \_LOW = Frequency\_LOW * Size\_MEDIUM$$

$$3. DDOS\_LEVEL \_LOW = Frequency\_HIGH * Size\_LOW$$

$$4. DDOS\_LEVEL \_VERY \_VERY \_MEDIUM = Frequency\_LOW * Size\_HIGH$$

$$5. DDOS\_LEVEL \_VERY \_MEDIUM = Frequency\_MEDIUM * Size\_LOW$$

$$6. DDOS\_LEVEL \_MEDIUM = Frequency\_MEDIUM * Size\_MEDIUM$$

$$7. DDOS\_LEVEL \_HIGH = Frequency\_MEDIUM * Size\_HIGH$$

$$8. DDOS\_LEVEL \_VERY \_HIGH = Frequency\_HIGH * Size\_MEDIUM$$

$$9. DDOS\_LEVEL \_VERY \_VERY \_HIGH = Frequency\_HIGH * Size\_HIGH$$

Following the inference phase, the adjectives induced by the rules are then obtained, as well as the membership of their output variable.

In the example, for the DDOS_LEVEL output variable, we then obtain:

| DDOS_LEVEL = { | | |
|---|---|---|
| VERY_VERY_LOW | : 0.6*0.25 | = 0.15 |
| VERY_LOW | : 0.6*0.75 | = 0.45 |
| LOW | : 0.0*0.25 | = 0 |
| VERY_VERY_MEDIUM: 0.6*0.0 | | = 0 |
| VERY_MEDIUM | : 0.4*0.25 | = 0.1 |
| MEDIUM | : 0.4*0.75 | = 0.3 |
| HIGH | : 0.4*0.0 | = 0 |
| VERY_HIGH | : 0.0*0.75 | = 0 |
| VERY_VERY_HIGH | : 0.0*0.0 | = 0 |

}

During the third fuzzy resolution phase, the inputs thus are constituted of the membership of the output variable to the adjectives induced by the rules of the inference engine. In the example, the adjectives are the following: VERY_VERY_LOW, VERY_LOW, LOW, VERY_VERY_MEDIUM, VERY_MEDIUM, MEDIUM, HIGH, VERY_HIGH, VERY_VERY_HIGH, and they classify the DDOS_LEVEL output variable.

The membership functions for these adjectives are triangular functions classified by their centers, for example, and extending from the previous center to the next center.

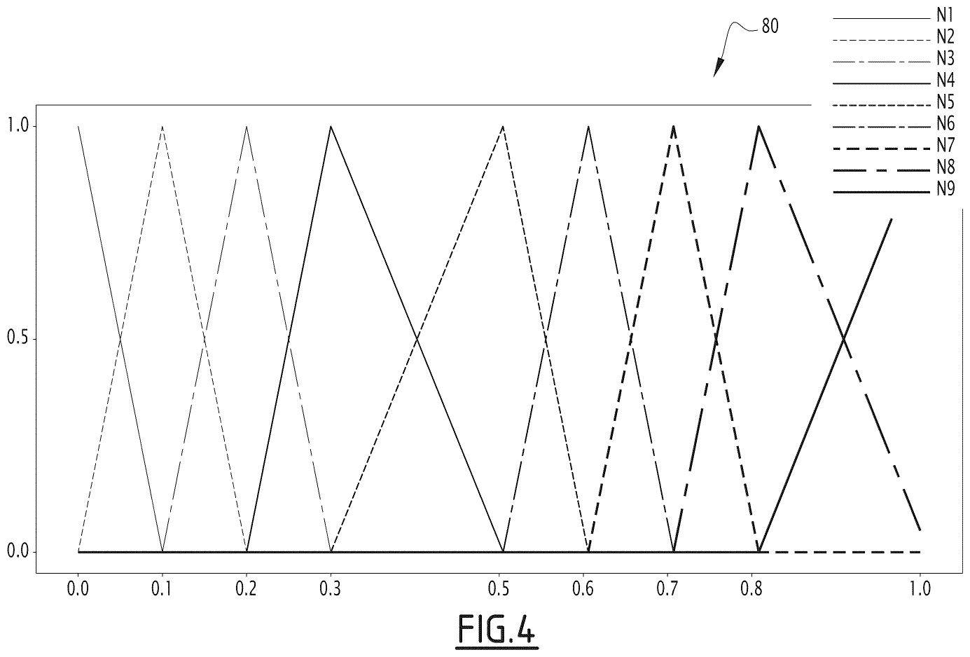

The membership functions of this example are then represented in FIG. 4, where view 80 shows the nine membership functions for each of the nine aforementioned adjectives, corresponding to nine successive levels, referenced N1 to N9 in FIG. 4. A first level N1 then corresponds to the adjective VERY_VERY_LOW, then a second level N2 to VERY_LOW, a third level N3 to LOW, a fourth level N4 to VERY_VERY_MEDIUM, a fifth level N5 to VERY_MEDIUM, a sixth level N6 to MEDIUM, a seventh level N7 to HIGH. In the example of FIG. 4, the centers of the nine membership functions are the following: {0; 0.1; 0.2; 0.3; 0.5; 0.6; 0.7; 0.8; 1}.

To calculate the final output value of the fuzzy inference system, the center of gravity method is used, for example, according to the following equations:

$$\begin{matrix}Output & = \frac{{\sum }_{rules} ( {weight}_{rules} * {MembershipArea}_{rules} )}{{\sum }_{rules} ( {MembershipArea}_{rules} )} \\ & \approx \frac{( 0 * 0.15 ) + ( 0.1 * 0.45 ) + ( 0.2 * 0 ) + ( 0.3 * 0 ) + ( 0.5 * 0.1 ) + ( 0.6 * 0.3 ) + ( 0.7 * 0 ) + ( 0.8 * 0 ) + ( 1 * 0 )}{0.15 + 0.45 + 0 + 0 + 0.1 + 0.3 + 0 + 0 + 0} \\ & \approx \frac{0.045 + 0.05 + 0.18}{1} \\ & \approx 0.2 75 \\ & \approx 27.5 \%\end{matrix}$$

The third fuzzy resolution phase then amounts to deducing the value of the output variable based on its characterization in the form of adjectives, and their underlying membership function, and it is thus a deterministic decision within a fuzzy description.

In the example, the value obtained for the DDOS attack level corresponding to the DDOS_LEVEL output variable is then estimated to be 27.5%, and this estimated value is then used by the restitution module 46 to perform an action such as launching a security reaction, for example.

The skilled person will observe that the learning of the fuzzy inference system then amounts to having the centers of the membership functions learned for the first fuzzy generation phase to characterize the inputs by the adjectives, to have the centers of the membership functions learned for the third fuzzy resolution phase to estimate an output value from the adjectives induced by the rules, and to have the best rules learned for the inference engine.

In other words, in the previous example, the elements learned during the learning are presented underlined below, and are therefore the centers of the membership functions, either for the frequency: {0; 0.5; 1}, for the size: {0; 0.7; 1} and for the DDOS level: {0; 0.1; 0.2; 0.3; 0.5; 0.6; 0.7; 0.8; 1}, as well as the following rules base:
1. IF {Frequency}LOW & {Size}LOW, THEN {DDOS LEVEL}VERY_VERY_LOW
2. IF {Frequency}LOW & {Size}MEDIUM, THEN {DDOS LEVEL}VERY_LOW
3. IF {Frequency}HIGH & {Size}LOW, THEN {DDOS LEVEL}LOW
4. IF {Frequency}LOW & {Size}HIGH, THEN {DDOS LEVEL}VERY_VERY_MEDIUM
5. IF {Frequency}MEDIUM & {Size}LOW, THEN {DDOS LEVEL}VERY_MEDIUM
6. IF {Frequency}MEDIUM & {Size}MEDIUM, THEN {DDOS LEVEL}MEDIUM
7. IF {Frequency}MEDIUM & {Size}HIGH, THEN {DDOS LEVEL}HIGH
8. IF {Frequency}HIGH & {Size}MEDIUM, THEN {DDOS LEVEL}VERY_HIGH
9. IF {Frequency}HIGH & {Size}HIGH, THEN {DDOS LEVEL}VERY_VERY_HIGH

These learned elements, such as the centers of the membership functions and the rules base, are then typically recorded in a database associated with the rules generation engine, to be subsequently executed during the inference of the artificial intelligence algorithm.

The previous example is relatively simple, and the skilled person will understand that the invention enables creating fuzzy decision trees by chaining several fuzzy inference systems in an embedded manner, to create more complex intelligence. The fuzzy inference systems are specifically likely to be interconnected by depth layers, to increase the intelligence level of the artificial intelligence algorithm, specifically with one or more intermediate variables between two successive fuzzy inference systems.

According to a second embodiment of the invention, the artificial intelligence algorithm implemented to obtain the set of functional rules includes a radial basis function network, or RBFN, hereinafter called the RBFN network. The RBFN network also has the advantage of making the set of functional rules explainable and predictable, or at least of simulating the behavior of a fuzzy logic decision tree.

The RBFN network includes an input layer of N input node(s), each input node receiving a value of a quantity related to the message, a single intermediate layer of H neuron(s), and an output layer of S output node(s), each output node providing an evaluation value; N, H, and S being integers greater than or equal to 1. Each neuron of the intermediate layer is characterized by a radial activation function centered on a center cₕ and radius rₕ, with h being an integer between 1 and N.

The preliminary learning of the RBFN network is performed through the implementation of gradient descent.

For the implementation of the invention according to the second embodiment, the RBFN network is transformed into a fuzzy inference system, via a transformation method as described in the application FR 24 12499 filed on Nov. 15, 2024, for example.

The method described in this application specifically enables designing an RBFN network while respecting some modern architecture constraints, then transforming the RBFN network into a fuzzy variant of the RBFN, also called FRBFN (Fuzzy Radial Basis Function Network), to be functionally equivalent to a fuzzy logic decision tree, which itself is convertible to a polynomial function.

This transformation of the RBFN network into an FRBFN network involves identifying rules corresponding to the aforementioned second phase during the generation of a fuzzy inference system, with this rule identification resulting from the trimming of a layer connection of the RBFN network.

The skilled person will also observe that the equivalence of the GFT rule base results from the presence or absence of a link between the radial basis neurons.

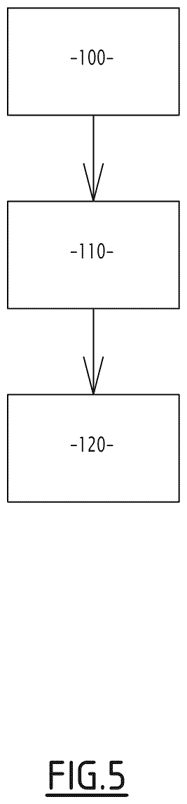

The operation of the electronic security device 25 will now be explained, specifically with the help of FIG. 5 representing a flowchart of the method, according to the invention, for securing data exchange(s) within the avionics communication installation 10 embedded on board the aircraft 5.

During an initial step 100, the electronic security device 25 acquires one or more data messages within the communication installation 10, via its acquisition module 42.

After the acquisition step 100, the electronic security device 25 processes the at least one message acquired during the acquisition step 100 via its processing module 44 and during a subsequent processing step 110.

The processing module 44 processes each acquired message by implementing the filtering function F and/or the detection function D and/or the reaction function R. The type of function implemented for processing each acquired message depends specifically on a desired type of protection to be implemented, among NIPS, HIPS and NIDS, for example.

In the example of FIG. 2, the processing module 44 implements the filtering function F for NIPS protection, for example, and/or the detection function D and the reaction function R for HIPS or NIDS protection.

According to the invention, during the processing step 110, each implemented function F, D, R includes a respective associated set of functional rules, which is obtained through the inference of the artificial intelligence algorithm. According to the first embodiment, the artificial intelligence algorithm includes the fuzzy logic decision tree. According to the second embodiment, the artificial intelligence algorithm includes the radial basis function network, known as the RBFN network.

After the processing step 110, the electronic security device 25 performs at least one action associated with the result obtained, via its restitution module 46 and during a subsequent restitution step 120, through the implementation of the filtering function F and/or the detection function D and/or the reaction function R.

The action performed is displaying the result on the display device, for example, or recording the result for later analysis, or issuing an alert related to the result, or generating based on the result a command instruction for a respective system, such as a respective avionics system 20.

After the restitution step 120, the electronic security device 25 typically returns to the acquisition step 100, to acquire one or more new data messages within the communication installation 10.

Thus, with the electronic security device 25 according to the invention, the artificial intelligence algorithm enables more efficiently generating the respective set of functional rules to be implemented to perform each respective processing function among the message filtering function F, the malicious behavior detection function D and the malicious behavior reaction function R, while enabling making each set of functional rules explainable and predictable. This then enables making each set of functional rules able to be audited and certified in an avionics context.

It is thus conceived that the electronic security device 25 and the security method according to the invention are more suitable for avionics certification than the state-of-the-art security devices and methods.

1. An electronic security device for securing data exchange(s) within an avionics communication installation embedded on board an aircraft, the security device being configured to be embedded on board the aircraft and comprising:
an acquisition module configured to acquire at least one data message within the communication installation;
a processing module configured to process the at least one acquired message by implementing at least one function chosen from the group comprising: a message filtering function, a malicious behavior detection function, and a reaction function to a malicious behavior;
a restitution module configured to perform at least one action associated with a result obtained through the implementation of the at least one function and chosen from the group comprising: displaying the result on a display device; recording the result for later analysis; issuing an alert related to the result; and generating a command instruction for a system based on the result;
wherein each function includes a set of functional rules obtained through the implementation of an artificial intelligence algorithm chosen from an artificial intelligence algorithm including a fuzzy logic decision tree and an artificial intelligence algorithm including a radial basis function network, known as RBFN; each functional rule being, respectively, a filtering rule for the filtering function, a detection rule for the detection function, and a reaction rule for the reaction function; each functional rule being an association rule configured to associate an output value with several discretized input values.

2. The device according to claim 1, wherein the fuzzy logic decision tree includes at least one fuzzy inference system, each fuzzy inference system being configured to receive at least one value of a quantity related to the message as input and to deliver an evaluation value as output; for each fuzzy inference system, a correspondence between input(s) and output is established by a fuzzy transformation of the inputs, to select the functional rule configured to associate an output value corresponding to several discretized input values.

3. The device according to claim 1, wherein the RBFN includes an input layer of N input node(s), with each input node receiving a value of a quantity related to the message, a single intermediate layer of H neuron(s), and an output layer of S output node(s), with each output node providing an evaluation value; N, H, and S being integers greater than or equal to 1, each neuron of the intermediate layer being characterized by a radial activation function centered on a center cₕ and radius rₕ, with h being an integer between 1 and N.

4. The device according to claim 1, wherein the artificial intelligence algorithm is trained via preliminary learning from training data.

5. The device according to claim 4, wherein the preliminary learning is a supervised learning.

6. The device according to claim 4, wherein the preliminary learning of the fuzzy logic decision tree is performed through the implementation of a genetic algorithm.

7. The device according to claim 4, wherein the preliminary learning of the RBFN is performed through the implementation of gradient descent.

8. The device according to claim 4, wherein the preliminary learning further includes, for each functional rule, an indication of the number of occurrences of the implementation of said rule during the preliminary learning.

9. An aircraft comprising an avionics communication installation and an electronic security device for securing data exchange(s) within said communication installation, the electronic security device being according to claim 1.

10. A method for securing data exchange(s) within an avionics communication installation embedded on board an aircraft, the security method being implemented by an electronic security device embedded on board the aircraft and comprising:
acquiring at least one data message within the communication installation;
processing the at least one acquired message by implementing at least one function chosen from the group comprising: a message filtering function, a malicious behavior detection function, and a reaction function to a malicious behavior;
performing at least one action associated with a result obtained through the implementation of the at least one function and chosen from the group comprising: displaying the result on a display device; recording the result for later analysis; issuing an alert related to the result; and generating a command instruction for a system based on the result;
wherein each function includes a set of functional rules obtained through the implementation of an artificial intelligence algorithm chosen from an artificial intelligence algorithm including a fuzzy logic decision tree and an artificial intelligence algorithm including a radial basis function network, known as RBFN; each functional rule being, respectively, a filtering rule for the filtering function, a detection rule for the detection function, and a reaction rule for the reaction function; each functional rule being an association rule configured to associate an output value with several discretized input values.

11. A non-transitory computer-readable medium including a computer program, including software instructions that implement a method according to claim 10 when executed by a computer.
